(19) United States
(12) Patent Application Publication
(10) Pub. No.: US 2004/0060850 A1
(43) Pub. Date: Apr. 1, 2004

(54) Water purifier

(75) Inventor: John Duncan McNair, Olinda (AU)

Correspondence Address: LEYDIG VOIT & MAYER, LTD, 700 THIRTEENTH ST. NW, SUITE 300, WASHINGTON, DC, 20005-3960, US

(73) Assignee: Chiaphua Industries Limited, Tai Po (HK)

(21) Appl. No.: 10/255,063

(22) Filed: Sep. 26, 2002

(51) Int. Cl. B01D 35/14

(52) U.S. Cl. 210/104; 210/109; 210/121; 210/257.1; 210/258

(57) ABSTRACT

A water purifier includes a first reservoir, a second reservoir having an outlet through which filtered water can be dispensed, and a pump for pumping water from the first reservoir to the second reservoir. Water passes through a filter from the first reservoir en route to the second reservoir upon activation of the pump. There is a first water level detector in the first reservoir and a second water level detector in the second reservoir. A switch co-operates with the second water level detector to activate the pump when a reduced water level is detected in the second reservoir by the second water level detector. The switch also co-operates with the first water level detector to deactivate the pump, should the first water level detector detect a low water level in the first reservoir. A single switch performs both tasks.

### BACKGROUND OF THE INVENTION

The present invention relates to water purifiers. More particularly, although not exclusively, the invention relates to a water purifier having two water reservoirs, one of which stores a quantity of filtered water for dispensation.

Water filters for purifying potable water often have a slow water throughput rate requiring one to hold his or her cup, jug or other vessel under the filtered water outlet for quite some time as filtration takes place. This problem is exacerbated where high-quality/low pore sized filtration materials are adopted to remove microscopic particles, bacteria and other contaminants from the water.

### OBJECTS OF THE INVENTION

It is an object of the present invention to overcome or substantially ameliorate the above disadvantage and/or more generally to provide improved water purifier.

It is another object of the present invention to provide a water purifier having a filtered water reservoir, the contents of which can be dispensed rapidly on demand.

### DISCLOSURE OF THE INVENTION

There is disclosed herein a water purifier comprising:

a first reservoir,

a second reservoir having an outlet through which filtered water can be dispensed,

a pump for pumping water from the first reservoir to the second reservoir,

a filter through which water from the first reservoir passes en route to the second reservoir upon activation of the pump,

a first water level detector in the first reservoir,

a second water level detector in the second reservoir,

a switch co-operating with the second water level detector to activate the pump when a reduced water level is detected in the second reservoir by the second water level detector, the switch also co-operating with the first water level detector to deactivate the pump, should the first water level detector detect a low water level in the first reservoir.

Preferably the first water level detector comprises a first float.

Preferably the second water level detector comprises a second float.

Preferably the water purifier comprises a lever, to opposed ends of which the first and second floats are attached at opposite sides of a pivot point.

Preferably the lever co-operates with the switch.

Preferably the first float is attached to the lever by a lost motion mechanism.

Preferably the lost motion mechanism comprises an extendable linkage attaching the first float to the lever.

Preferably the extendable linkage is a chain.

Preferably the second float is attached directly to the lever.

Preferably the first float acts on the lever to induce a moment therein greater than an opposite moment induce therein by the second float.

Preferably the mass of the first float induces a higher moment in the lever than that of the second float.

Preferably there is a return pipe extending from the second reservoir to the first reservoir.

Preferably the first and second reservoirs are separated by a space.

Preferably the pump is situated within the first reservoir to be submerged therein.

Preferably the filter is situated within the first reservoir.

Preferably the second reservoir has an actuator for opening the dispensing outlet on demand.

### BRIEF DESCRIPTION OF THE DRAWINGS

A preferred form of the present invention will now be described by way of example with reference to the accompanying drawings, wherein:

FIG. 1 is a schematic cross-sectional elevational view of a water purifier in a steady/both reservoirs full state,

FIG. 2 is a schematic cross-sectional elevational view of the water purifier having the water level in the second reservoir reduced, and

FIG. 3 is a schematic cross-sectional elevational view of the water purifier having the water level in the first reservoir near empty.

### DESCRIPTION OF THE PREFERRED EMBODIMENT

In the accompanying drawings there is schematically depicted a water purifier 10. Purifier 10 includes a first reservoir 11 and the second reservoir 12. There is a space 30 between the two reservoirs for preventing contamination of filtered water within the second reservoir 12 by splashing of water from reservoir 1.

Located in the bottom of the first reservoir 11 within a sealed housing is a pump motor 15 driving an impeller 16. There is a pipe 13 extending from the impeller housing to a filter 14. The pipe extends to an outlet 18 at the top of the second reservoir 12. Water from reservoir 11 passes into the impeller at housing at 17 upon activation of motor 15.

There is a return pipe 28 sloped downwardly from the second reservoir 12 to the first reservoir 11. There is a flap 29 where the return pipe 28 joins the first reservoir 11 to prevent water from within the first reservoir passing unfiltered into the second reservoir.

There is a water dispensing port 19 at the bottom of the second reservoir 12 having a plug 21 that keeps the dispensing port closed until a mechanical actuator 20 is activated to raise the plug for dispensing water.

Attached to the top of the apparatus at pivot point 23 is a lever 22. At the first reservoir side of the pivot point 23, the lever 22 has attached thereto by means of a chain 27 a float 25. Any other lost motion mechanism could alternatively be provided. Attached to the lever 22 at the opposite side of the pivot point 23 is a second float 26. There is no lost motion mechanism at this float as it is fixed directly to the lever 22.

There is a push-on/release-off electric switch 24 fixed with respect to the water purifier 10 and engaging with the lever 22. As an alternative, the switch 24 could be mounted on the lever 22 for engaging with a fixed part of the water purifier. The switch opens and closes an electric circuit to the motor 15. That is, operation of switch 24 activates or deactivates that pump impeller 16 to thereby pump water from reservoir 11 through filter 14 to reservoir 12.

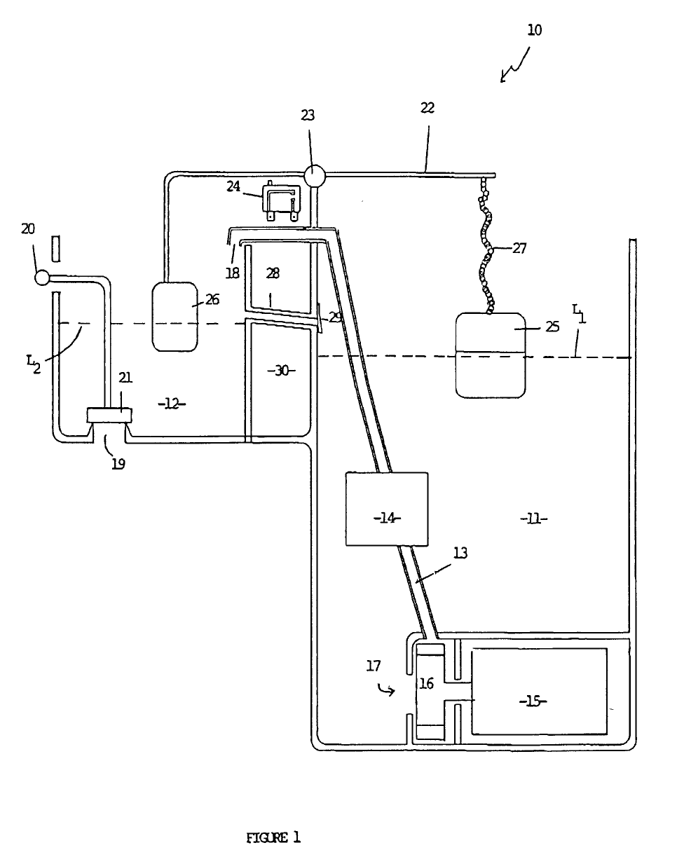

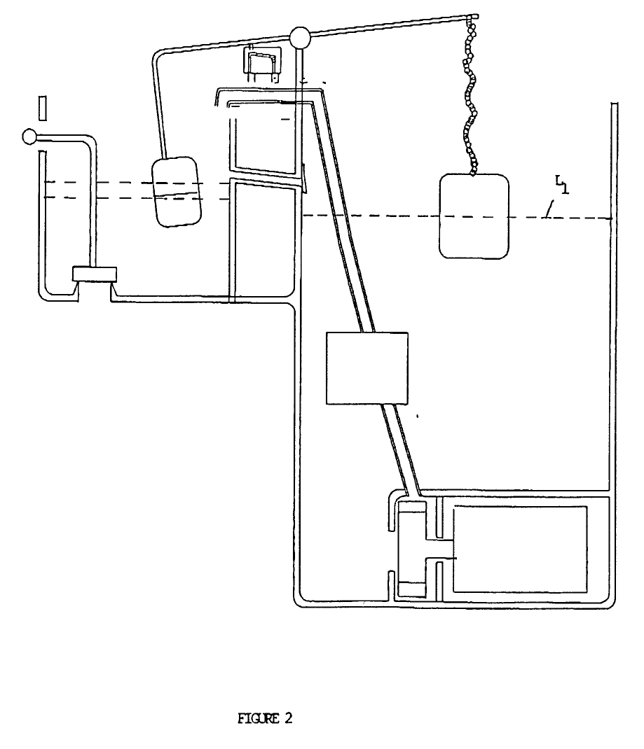

In use, the first reservoir 11 is filled with water so that the water level reaches L₁ as depicted in FIG. 1. This is typically a level just beneath the flap 29. During the filling process, the float 25 will raise to the position depicted in FIG. 1. If the second reservoir 12 is empty or low on water, the weight of float 26 will draw the left-hand side of the lever 22 down upon the switch 24. This situation is depicted in FIG. 2 wherein the pump is operational to deliver filtered water to the second reservoir 12. That is, the impeller 16 will draw water in at 17 and force it through filter 14 for delivery to reservoir L₂ via outlet 18. When the water level in reservoir 12 reaches L₂, the float 26 will raise so as to lift the left-hand portion of lever 22 away from switch 24 to thereby deactivate the pump.

If too much filtered water is delivered to reservoir 12, it is allowed to return to the first reservoir 11 via return pipe 28.

When water is dispensed through outlet port 19 upon activation of mechanical switch 20, the float 26 will lower to result in reactivation of the motor to thereby commence delivery of water through the filter to the second reservoir again.

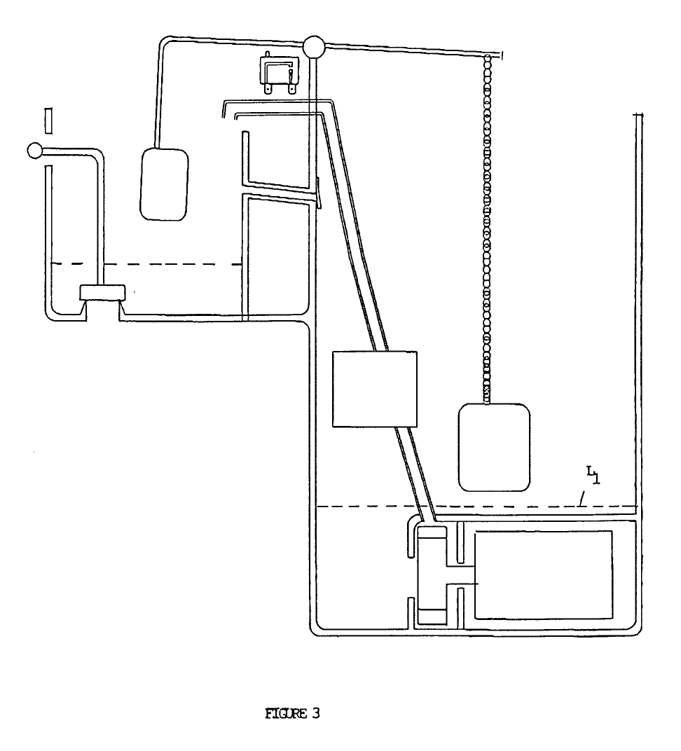

The motor should not operate if the water level L₁ is too low. That is, the pump should not be run dry. This is the reason why float 25 is attached to the lever 22 by a lost motion mechanism, which, in the preferred embodiments is in the form of a chain 27. That is, the chain can extend as float 25 descends without affecting the lever 22 until chain 27 becomes taut. This occurs just before the first reservoir runs dry as shown in FIG. 3. As the moment about pivot point 23 caused by the mass of float 25 is greater than that in the opposite direction induced by the mass of float 26, a low water level state in reservoir 11 will override any effect on switch 24 induced by the level of water L₂ in reservoir 12. That is, when float 25 is in the position depicted in FIG. 3, the switch 24 is open and therefore there is no current available to the motor.

Both of the floats 25 and 26 should be buoyant, but the mass of float 25 can be greater than that of float 26, depending upon the configuration of lever 22.

The first reservoir can be filled manually with water, or might be connected to a water main. In the tatter case, there ought to be a separate flow valve arrangement preventing overfilling of the first reservoir.

It should be apparent that the second reservoir 12 contains a sufficient amount of water to fill a jug, glass, or saucepan without any delay associated with the filtration of the water. The next time that filtered water is required would normally be some time afterwards, during which time the reservoir 12 can be filled relatively slowly by operation of the pump.

It should be appreciated that modifications and alterations obvious to those skilled in the art are not to be considered as beyond the scope of the present invention. For example, instead of providing a lever and mechanical switch, there could be light sensors or other water level sensors at each reservoir connected to an electronic circuit providing systems logic equivalent to that provided by the mechanical arrangement depicted. Furthermore, where floats are provided, they might be situated within respective vertical tubular enclosures having an opening at the bottom through which water from the respective reservoir can pass. Such an arrangement would prevent inadvertent movement of the mechanism and activation of the switch caused by sloshing of water in either reservoir. Also, the mechanical actuator might be replaced by a remote electrical activation switch where an electric solenoid valve is used at dispensing port 19 instead of the plug 21.

1. A water purifier comprising:
a first reservoir,
a second reservoir having an outlet through which filtered water can be dispensed,
a pump for pumping water from the first reservoir to the second reservoir,
a filter through which water from the first reservoir passes en route to the second reservoir upon activation of the pump,
a first water level detector in the first reservoir,
a second water level detector in the second reservoir,
a switch co-operating with the second water level detector to activate the pump when a reduced water level is detected in the second reservoir by the second water level detector, the switch also co-operating with the first water level detector to deactivate the pump, should the first water level detector detect a low water level in the first reservoir.

2. The water purifier of claim 1 wherein the first water level detector comprises a first float.

3. The water purifier of claim 1 wherein the second water level detector comprises a second float.

4. The water purifier of claim 1 further comprising a lever, to opposed ends of which the first and second floats are attached at opposite sides of a pivot point.

5. The water purifier of claim 4 wherein the lever cooperates with the switch.

6. The water purifier of claim 4 wherein the first float is attached to the lever by a lost motion mechanism.

7. The water purifier of claim 6 wherein the lost motion mechanism comprises an extendable linkage attaching the first float to the lever.

8. The water purifier of claim 7 wherein the extendable linkage is a chain.

9. The water purifier of claim 4 wherein the second float is attached directly to the lever.

10. The water purifier of claim 4 wherein the first float acts on the lever to induce a moment therein greater than an opposite moment induced therein by the second float.

11. The water purifier of claim 4 wherein the first float is heavier than the second float.

12. The water purifier of claim 1 wherein there is a return pipe extending from the second reservoir to the first reservoir.

13. The water purifier of claim 1 wherein the first and second reservoirs are separated by a space.

14. The water purifier of claim 1 wherein the pump is situated within the first reservoir to be submerged therein.

15. The water purifier of claim 1 wherein the filter is situated within the first reservoir.

16. The water purifier of claim 1 wherein the second reservoir has an actuator for opening the dispensing outlet on demand.
